(19) United States
(12) Patent Application Publication
(10) Pub. No.: US 2009/0199555 A1
(43) Pub. Date: Aug. 13, 2009

(54) Braking system and automatic brake actuator

(75) Inventor: Kunimichi Hatano, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 12/319,371

(22) Filed: Jan. 5, 2009

(30) Foreign Application Priority Data
Feb. 12, 2008 (JP) 2008-30040

(51) Int. Cl. F15B 7/00

(52) U.S. Cl. 60/545

(57) ABSTRACT

A braking system comprising wheel cylinders that brake respective wheels when brake-fluid pressure is applied to the wheel cylinders, a master cylinder that generates brake-fluid pressure in response to a braking action of a driver, and an actuator including a slave cylinder and an electric motor, which is disposed between the master cylinder and the wheel cylinders, and which generates brake-fluid pressure by a forward motion of a piston driven by a driving power of the electric motor. The actuator is activated by an electric signal independent of a braking action of the driver and the actuator is activated only when the wheel cylinders are to be automatically activated without relying on the braking action of the driver.

### CROSS-REFERENCE TO RELATED APPLICATIONS

The present invention claims priority under 35 USC §119 based on Japanese patent application No 2008-30040 filed 12 Feb. 2008. The subject matter of these priority documents is incorporated by reference herein.

### BACKGROUND OF THE INVENTION

1. Field of the Invention

The present invention relates to a braking system comprising: a master cylinder that generates brake-fluid pressure by an operational force caused by a braking action of a driver; wheel cylinders that brake respective wheels; and a slave cylinder which is disposed between the master cylinder and the wheel cylinders, and which generates brake-fluid pressure by a forward motion of a piston driven by a driving power of an electric motor activated by an electric signal according to a braking action of the driver. The present invention also relates to an automatic-braking actuator which carries out a braking control by supplying brake-fluid pressure to wheel cylinders that brake respective wheels, and which may be used with the braking system.

2. Description of the Related Art

Japanese Patent Application Laid-Open No. 2005-343366 discloses what is known as a brake-by-wire (BBW) type braking system. In the disclosed BBW type braking system, a braking action of the driver is converted into an electric signal to actuate a motor cylinder functioning as electrical braking force generator, and the brake-fluid pressure generated by the motor cylinder operates the wheel cylinders.

Meanwhile, suppose a case of a congestion follow-up travel control in which the distance between a subject vehicle and a preceding vehicle is detected by means of a radar apparatus or the like. Then, the subject vehicle is automatically started and stopped in response to the starting and the stopping of the preceding vehicle. Automatic braking control for the congestion follow-up travel control is conventionally implemented by automatically actuating an electronically-controlled vacuum booster to make a master cylinder generate brake-fluid pressure, even without the driver's action of depressing the vehicle's brake pedal.

Suppose another case of a braking system including an antilock braking system (ABS) and/or a vehicle stability assist (VSA) system, such as described herein below, set between a master cylinder and each wheel cylinder of the system. In this case, automatic braking control for the congestion follow-up travel control is implemented by means of brake-fluid pressure that is generated by actuating hydraulic pumps provided in the ABS and/or in the VSA system.

In the former case, when the driver depresses the brake pedal while the electronically-controlled vacuum booster is in operation this brings about the following problem. With reference to FIG. 4, a brake-pedal stroke without any load continues until the piston stroke of the master cylinder caused by the depressing of the brake pedal reaches the piston stroke of the master cylinder caused by the actuation of the electronically-controlled vacuum booster. This may possibly give a significantly strange feeling/sensation to the driver (see the characteristic represented by the dashed line a in FIG. 4, while noting that the solid line in FIG. 4 represents the characteristic at the time when the electronically-controlled vacuum booster is not in operation).

The latter case has the following problems. The hydraulic pumps provided in the ABS and/or in the VSA system have difficulty in generating, with precision, the low brake-fluid pressure needed for the congestion follow-up travel control. In addition, the hydraulic pumps in operation cause noise and vibrations.

### SUMMARY OF THE INVENTION

The present invention has been made in view of the above-described circumstances. An object of the present invention is to provide a braking system which can achieve precise control of brake-fluid pressure for automatic braking control that is independent of the braking action of the driver, as well as to give the driver an enhanced braking feeling when the driver depresses a brake pedal during the automatic braking control.

In order to achieve such object, according to a first feature and aspect of the present invention, there is provided a braking system comprising: wheel cylinders that brake respective wheels when brake-fluid pressure is applied to the wheel cylinders; a master cylinder that generates brake-fluid pressure in response to a braking action of a driver; and an actuator including a slave cylinder and an electric motor, which is disposed between the master cylinder and the wheel cylinders, and which generates brake-fluid pressure by a forward motion of a piston driven by a driving power of the electric motor, wherein the actuator is activated by an electric signal independent of a braking action of the driver, and wherein the actuator is activated only when the wheel cylinders are to be automatically activated without relying on the braking action of the driver.

With the configuration described above, the actuator, including the slave cylinder and the electric motor, is disposed between the master cylinder and the wheel cylinders, and generates brake-fluid pressure by the forward motion of the piston that is driven by the driving power of the electric motor. The actuator is activated by the electric signal independent of a braking action of the driver. In addition, the electric motor of the actuator is activated only when the wheel cylinders are controlled to brake their respective wheels are automatically. Accordingly, the vibration and noise produced in the case of the above-described configuration can be reduced in comparison with a case where the brake-fluid pressure to activate the wheel cylinders is generated by driving a hydraulic pump. In addition, the actuator is activated only when the wheel cylinders are to be automatically activated. Accordingly, simultaneous occurrence of the operation of the slave cylinder and the braking action of the driver becomes less frequent. This reduces the impact of the operation of the actuator on the sensation experienced by the driver at the time of the braking action.

According to a second feature and aspect of the present invention, in addition to the first feature and aspect, there is provided the braking system further comprising a brake-fluid pressure adjusting device which is disposed between the slave cylinder and the wheel cylinders, and which is capable of adjusting, individually, the brake-fluid pressure supplied to the wheel cylinders.

With the configuration described above, the brake-fluid pressure adjusting device which is capable of adjusting, individually, the brake-fluid pressure supplied to the wheel cylinders is disposed between the slave cylinder and the wheel cylinders. This enables the antilock braking control to suppress the locking of the wheels and the control of the vehicle behavior by the distribution of the braking force between the wheels on the right-hand side and the wheels on the left-hand side of the vehicle and/or between the wheels on the front side and the wheels on the rear side of the vehicle.

According to a third feature and aspect of the present invention, in addition to the first feature and aspect, the slave cylinder includes: a cylinder main body into which the piston is slidably fitted; a port which is formed in the cylinder main body, and which communicates with the master cylinder; a cup seal disposed on the piston; and a reservoir chamber which is formed on an outer circumference of the piston at a position located at a rear side of the cup seal, and which communicates with the master cylinder, wherein when the piston moves forward and thereby the cup seal passes by the port, the slave cylinder generates brake-fluid pressure, and when the, actuator is automatically activated, the slave cylinder is put under a feedback control so as to make the slave cylinder generate a target brake-fluid pressure.

With the configuration described above, the slave cylinder includes: the cylinder main body in which the port communicating with the master cylinder is formed and into which the piston is slidably fitted; the cup seal provided to the piston; and the reservoir chamber which is formed at a position located at the rear side of the cup seal. Accordingly the slave cylinder can generate brake-fluid pressure when the piston moves forward and thereby the cup seal passes by the port. Suppose a case where, in the above-described state, the driver activates the master cylinder and thus generates brake-fluid pressure exceeding the brake-fluid pressure generated by the slave cylinder. In this case, the brake-fluid pressure is made to pass beyond the cup seal from the reservoir chamber and then to be supplied to the wheel cylinders. Accordingly, the braking control by the braking action of the driver can be made possible. In addition, while the electric motor is made to operate automatically without relying on any braking actions taken by the driver, the slave cylinder is put under the feedback control so as to generate the target brake-fluid pressure. Accordingly, the driver's depressing the brake pedal during the automatic braking control brings about an abrupt increase in the pedal force until the pedal force reaches the level corresponding to the target brake-fluid pressure. The master cylinder never makes a stroke while the pedal force is kept at a level that is almost equal to zero. As a consequence, the strange sensation experienced by the driver in a conventional system can be solved/overcome.

According to a fourth feature and aspect of the present invention, in addition to the first feature and aspect, there is provided the braking system further comprising two parallel systems of fluid passages connecting the master cylinder and the wheel cylinders, wherein the slave cylinder provides brake-fluid pressure to the fluid passages of both the two parallel systems.

With the configuration described above, the two parallel systems of fluid passages are provided for connecting the master cylinder and the wheel cylinders. Accordingly, if one of the two systems was to fail for any reason, the other system can provide the back-up for the failed one. In addition because only one slave cylinder is used to provide brake-fluid pressure to the two fluid passage systems, this reduces the number of the component parts.

According to a fifth feature and aspect of the present invention, in addition to the first feature and aspect, the slave cylinder is activated during the operation of a congestion follow-up travel control that makes a subject vehicle automatically start and stop in response to the start and the stop of a preceding vehicle.

With the configuration described above, the slave cylinder is activated during the operation of the congestion follow-up travel control that makes the subject vehicle automatically start and stop in response to the start and the stop of the preceding vehicle. Accordingly, frequent braking actions of the driver are no longer necessary during the congestion follow-up travel control, so that the number of actions required to be performed by the driver can be reduced.

According to a sixth feature and aspect of the present invention, there is provided an automatic-braking actuator which carries out a braking control by supplying brake-fluid pressure to wheel cylinders which are provided for respective wheels, the automatic-braking actuator comprising an electric motor that generates brake-fluid pressure by driving forward a piston slidably fitted into a cylinder main body, wherein the electric motor is activated only when the wheel cylinders are to be automatically activated without relying on any braking actions of a driver.

With the configuration described above, the electric motor generates brake-fluid pressure by driving forward the piston which is slidably fitted into a cylinder main body. The electric motor is activated to provide brake-fluid pressure only when the wheel cylinders are to be automatically activated without relying on any braking actions by the driver. Accordingly, braking force can be generated even without the driver applying any force to the brake pedal. In addition, the brake-fluid pressure is generated by making the electric motor drive the piston of the slave cylinder, so that the vibrations and noise can be reduced in comparison with a case where a hydraulic pump is driven to generate brake-fluid pressure. Moreover, the automatic braking actuator is activated only when the wheel cylinder is to be automatically activated by the brake-fluid pressure from the actuator. Accordingly, the simultaneous occurrence of the operation of the automatic braking actuator and the braking actions of the driver becomes less frequent. This can reduce an impact of the operation of the automatic braking actuator on the sensation experienced by the driver at the time of the braking action.

According to a seventh feature and aspect of the present invention, in addition to the sixth feature and aspect, the electric motor is activated during a congestion follow-up travel control that makes a subject vehicle automatically start and stop in response to the start and the stop of the preceding vehicle.

With the configuration described above, the electric motor is activated during the congestion follow-up travel control that makes the subject vehicle automatically start and stop in response to the start and the stop of the preceding vehicle. Accordingly, frequent braking actions of the driver are no longer necessary during the congestion follow-up travel control, so that the number of actions required to be performed by the driver can be reduced.

The above-described and other objects, features, and advantages of the present invention will be apparent through description, in detail, of a preferred embodiment to be given with reference to the accompanying drawings.

### BRIEF DESCRIPTION OF THE DRAWINGS

FIGS. 1 to 3 show an exemplary embodiment of the present invention.

FIG. 1 is a hydraulic-circuit diagram of a vehicle braking system according to an exemplary embodiment of the present invention.

FIG. 2 is an enlarged diagram of a slave cylinder of FIG. 1.

FIG. 3 is a graph illustrating the relation between the stroke of a brake pedal and a reaction force.

FIG. 4 is a graph illustrating the relation between the stroke of a brake pedal and a reaction force according to a conventional example.

### DETAILED DESCRIPTION OF THE PRESENT EXEMPLARY EMBODIMENT

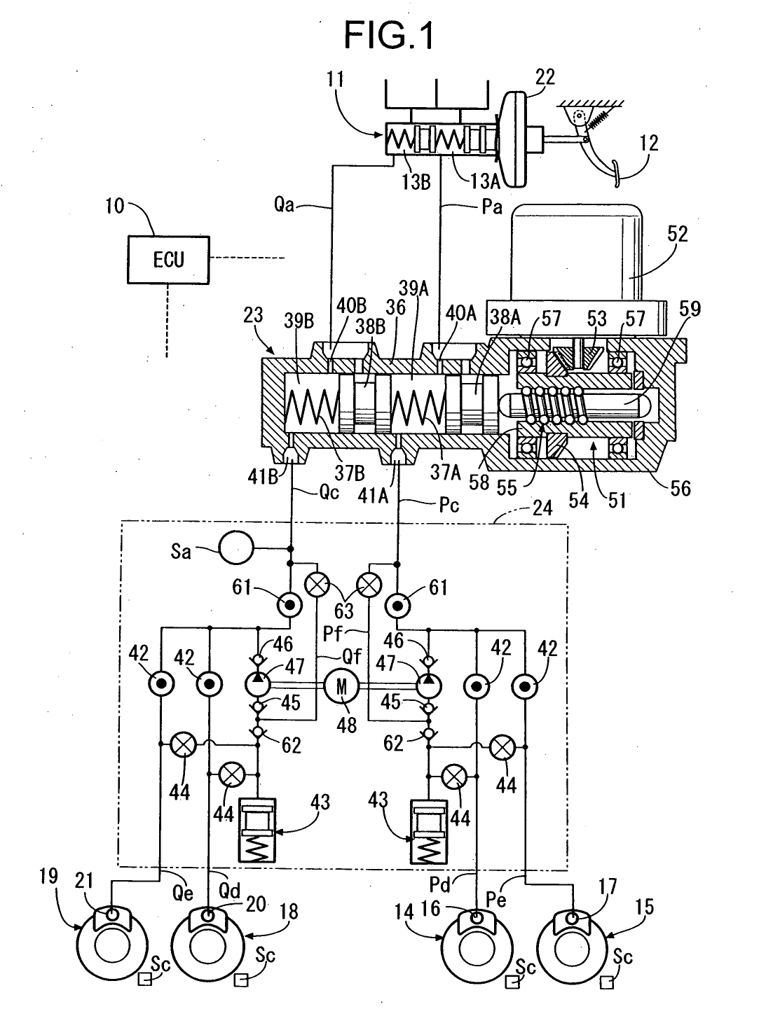

An exemplary embodiment of the present invention will be described below with reference to FIGS. 1 to 3.

As shown in FIG. 1, a tandem-type master cylinder 11 is provided with a vacuum booster 22. The master cylinder 11 includes first hydraulic chambers 13A and 13B that output brake-fluid pressure in accordance with the pedal force generated when a driver depresses a brake pedal 12. The first hydraulic chamber 13A is connected, for example, to a wheel cylinder 16 of a disc-brake apparatus 14 of the left-hand-side front wheel via fluid passages Pa, Pc, and Pd. In addition, the first hydraulic chamber 13A is connected, for example, to a wheel cylinder 17 of a disc-brake apparatus 15 of the right-hand-side rear wheel via fluid passages Pa, Pc, and Pe. The other first hydraulic chamber 13B is connected, for example, to a wheel cylinder 20 of a disc-brake apparatus 18 of the right-hand-side front wheel via fluid passages Qa, Qc, and Qd. In addition, the first hydraulic chamber 13B is connected, for example, to a wheel cylinder 21 of a disc-brake apparatus 19 of the left-hand-side rear wheel via fluid passages Qa, Qc, and Qe.

A slave cylinder 23 is disposed both between the fluid passages Pa and Pc and between the fluid passages Qa and Qc. An actuator 51 that the slave cylinder 23 is provided with includes: a drive bevel gear 53 provided on the rotational shaft of an electric motor 52; a driven bevel gear 54 meshing with the drive bevel gear 53; and a ball screw mechanism 55 that is made to operate by the driven bevel gear 54. A sleeve 58 is rotatably supported by an actuator housing 56 with a pair of ball bearing 57, 57 set in between. An output shaft 59 is coaxially disposed on the inner circumference of the sleeve 58 while the driven bevel gear 54 is fixed on the outer circumference of the sleeve 58.

A pair of pistons 38A and 38B are slidably disposed inside a cylinder main body 36 of the slave cylinder 23. A pair of return springs 37A and 37B are provided to bias, respectively, the pair of pistons 38A and 38B in the backward direction. A pair of second hydraulic chambers 39A and 39B are formed, respectively, at the front side of the piston 38A and at the front side of the piston 38B. The front end of the output shaft 59 abuts on the rear end of the rear-side piston 38A. The second hydraulic chambers 39A communicates with the fluid passage Pa via an inlet port 40A and to the fluid passage Pc via an outlet port 41A. The other second hydraulic chamber 39B communicates with the fluid-passage Qa via an inlet port 40B and to the fluid passage Qc via an outlet port 41B.

A reservoir chamber 38a is formed in the outer circumference of the piston 38A for the purpose of prohibiting entry of air into the second hydraulic chamber 39A while a reservoir chamber 38b is formed in the outer circumference of the piston 38B for the purpose of prohibiting entry of air into the second hydraulic chamber 39B. Both the inlet port 40A of the second hydraulic chamber 39A and a supply port 49A of the reservoir chamber 38a communicate with the first hydraulic chamber 13A of the master cylinder 11. The outlet port 41A of the second hydraulic chamber 39A communicates with the wheel cylinders 16 and 17. In addition, both the inlet port 40B of the second hydraulic chamber 39B and a supply port 49B of the reservoir chamber 38b communicate with the first hydraulic chamber 13B of the master cylinder 11. The outlet port 41B of the second hydraulic chamber 39B communicates with the wheel cylinders 20 and 21.

A first cup seal C1 is attached to the front-side end of the piston 38A so as to face forward (i.e., so as to produce its sealing effects when the piston 38A moves forward). A second cup seal C2 is attached to the rear-side end of the piston 38A so as to face forward. A third cup seal C3 is attached to the front-side end of the piston 38B so as to face forward. A fourth cup seal C4 is attached to the rear-side end of the piston 38B so as to face backward (i.e., so as to produce its sealing effects when the piston 38B moves backward).

The braking system of this exemplary embodiment is further provided with an ABS 24 to prevent the locking of the wheels. The ABS 24 also functions as a VSA to enhance the handling stability of the vehicle by producing a difference in braking force between the wheels on the right-hand side and the wheels on the left-hand side.

The ABS 24 has a known structure and is disposed at a position located between the fluid passage Pc on one side and the fluid passages Pd and Pe on the other side, as well as between the fluid passage Qc on one side and the fluid passages Qd and Qe on the other side. The sub-system both for the disc-brake apparatus 14 of the left-hand-side front wheel and for the disc-brake apparatus 15 of the right-hand-side rear wheel has an identical structure to the structure of the sub-system both for the disc-brake apparatus 18 of the right-hand-side-front wheel and for the disc-brake apparatus 19 of the left-hand-side rear wheel. Accordingly, description will be given by taking, as a representative example, the sub-system both for the disc-brake apparatus 14 of the left-hand-side front wheel and for the disc-brake apparatus 15 of the right-hand-side rear wheel. In-valves 42, 42 consisting of a pair of normally-open electromagnetic valves are disposed respectively between the fluid passage Pc and the fluid passage Pd and between the fluid passage Pc and the fluid passage Pe. In addition, out-valves 44, 44 consisting of a pair of normally-closed electromagnetic valves are disposed respectively between a reservoir 43 and the fluid passage Pd located at the downstream side of the in-valve 42 and between the reservoir 43 and the fluid passage Pe located at the downstream side of the in-valve 42. A hydraulic pump 47 is disposed between the reservoir 43 and the fluid passage Pc, while a pair of check valves 45 and 46 are disposed respectively at the two sides of the hydraulic pump 47. An electric motor 48 is provided to drive the hydraulic pump 47, which is activated by an electric signal coming from an electronic control unit 10.

The ABS 24 further has the following configuration so as to exhibit functions of a VSA. Specifically, regulator valves 61, 61, consisting of normally-open electromagnetic valves, are provided respectively at a position located before the branching point where fluid passages Pd and Pe branch off from the fluid passage Pc and at a position located before the branching point where the fluid passages Qd and Qe branch off from the fluid passage Qc. An arbitrary control of the opening degree is possible for each of the regulator valves 61, 61. Check valves 62, 62 are disposed respectively in series with the check valves 45, 45. A fluid passage Pf branches off from the fluid passage connecting the check valve 45 and the check valve 62 on one side while a fluid passage Qf branches off from the fluid passage between the check valve 45 and the check valve 62 on the other side. The fluid passage Pf is connected to the fluid passage Pc at a position located at the upstream side of the corresponding regulator valve 61 while the fluid passage Qf is connected to the fluid passage Qc at a position located at the upstream side of the corresponding regulator valve 62. Suction valves 63, 63 consisting of normally-open electromagnetic-valves are disposed respectively in the course of the fluid passage Pf and in the course of the fluid passage Qf.

Note that in the following exemplary embodiment, ABS 24 corresponds to the break-fluid pressure adjusting device, inlet ports 40A and 40B correspond to ports of the present invention, and first and third cup seals C1 and C3 correspond to cup seals of the present invention.

Next, operations of the exemplary embodiment of the present invention with the above-described configuration will be described below.

The slave cylinder 23 acts only at the time when the congestion follow-up travel control is in operation. When the congestion follow-up travel control is not in operation, the pistons 38A and 38B stay at their respective backward positions as shown in FIG. 1, and the inlet ports 40A and 40B are opened. Suppose that, in this state, the driver depresses the brake pedal 12 and makes the first hydraulic chambers 13A and 13B of the master cylinder 11 generate brake-fluid pressure. Then, the brake-fluid pressure of the first hydraulic chamber 13A is transmitted through the fluid passage Pa, and then through the inlet port 40A, the second hydraulic chamber 39A, and the outlet port 41A of the slave cylinder 23. Subsequently, the brake-fluid pressure is transmitted through the fluid passage Pc, the opened regulator valve 61 and then the in-valves 42 and 42 of the ABS 24. After that, the brake-fluid pressure is transmitted through the fluid passage Pd to the wheel cylinder 16, and through the fluid passage Pe to the wheel cylinder 17. Likewise, the brake-fluid pressure of the other first hydraulic chamber 13B is transmitted through the fluid passage Qa, and then through the inlet port 40B, the second hydraulic chamber 39B, and the outlet port 41B of the slave cylinder 23. Subsequently, the brake-fluid pressure is transmitted through the fluid passage Qc, the opened regulator valve 61 and then the in-valves 42 and 42 of the ABS 24. After that, the brake-fluid pressure is transmitted through the fluid passage Qd to the wheel cylinder 20, and through the fluid passage Qe to the wheel cylinder 21.

As described above, in a normal operation, the wheel cylinders 16, 17, 20, and 21 are made to act by the brake-fluid pressure generated in the master cylinder 11 by the driver's action of applying pressure to the brake pedal 12.

Subsequently, the operations at the time of the ABS control will be described. Suppose a case where, while a braking operation in a normal operation is on going, a fact that the slip ratio of any one of the wheels increases and that the wheel is likely to be locked is detected on the basis of the output of wheel-speed sensors Sc. In this case, the locking of the wheel is prevented by activating the ABS 24.

Specifically, when one of the wheels is likely to be locked, the in-valve 42 that is connected to the wheel cylinder of the disc-brake apparatus for that wheel is closed to block the transmission of the brake-fluid pressure from the master cylinder 11. Then, in this state, the out-valve 44 for the wheel is opened to perform a pressure-reduction operation to let the brake-fluid pressure of the wheel cylinder into the corresponding reservoir 43. Subsequently, the out-valve 44 is closed to perform a maintaining operation to maintain the brake-fluid pressure of the wheel cylinder. Accordingly, the braking force for the wheel is lowered so as to prevent the wheel from being locked.

Once the wheel speed is recovered enough to lower the slip rate as a consequence of the above-mentioned operations, the in-valve 42 is opened to perform a pressure-increase operation to increase the brake-fluid pressure of the wheel cylinder. The braking force for the wheel is thus increased. When the wheel is likely to be locked as a consequence of this pressure-increase operation, the pressure-reduction, the maintaining, and the pressure-increase operations are performed again. Repeating these operations makes it possible to generate maximum braking force for the wheel while the locking of the wheel can be suppressed. The brake-fluid that flows into the reservoir 43 during the above-mentioned operations is returned, by the hydraulic pump 47, back to the upstream side of the corresponding fluid passage Pc or Qc.

Subsequently, the operations at the time of the VSA control will be described. Suppose a case where the vehicle is over-steering while the vehicle is turning. In this case, a yaw moment to counter the over-steering is generated by activating the wheel cylinders of the wheels on the outer side of the turn. In a case where the vehicle is under-steering while the vehicle is turning, a yaw moment to counter the under-steering is generated by activating the wheel cylinders of the wheels on the inner side of the turn. To make the generation of the yaw moment occur in each of the above-described cases, the braking forces of the wheel cylinders on the right-hand side and on the left-hand side can be controlled individually.

Specifically, suppose a case where the suction valves 63, 63 are excited and opened, and where the hydraulic pumps 47, 47 are activated with the suction valves 63, 63 being open. In this case, the brake fluid is sucked from a reservoir of the master cylinder 11 via the suction valves 63, 63 so as to generate brake-fluid pressure at the upstream side of each of the in-valves 42. The brake-fluid pressure can be adjusted at a predetermined level by exciting and controlling the regulator valves 61, 61 at a predetermined opening degree.

In this state, the in-valve 42 for the wheel that does not have to be controlled is closed so as to prevent the transmission of the brake-fluid pressure to the corresponding wheel cylinder. Meanwhile, the in-valve 42 for the wheel that has to be controlled is opened so as to allow the transmission of the brake-fluid pressure to the corresponding wheel cylinder. Accordingly, the wheel cylinder can be activated, and thus a braking force can be generated. The control of the increasing of, the decreasing of, and the maintaining of the brake-fluid pressure to be transmitted to the wheel cylinder is accomplished by opening and closing the in-valve 42 and the out-valve 44, as in the case of the ABS control.

As described above, the braking of the wheels on either one of the right side and the left side of the vehicle by means of the VSA control allows a yaw moment in an arbitrary direction to be generated, so that the handling stability of the vehicle can be enhanced.

Subsequently, the operations at the time of the congestion follow-up travel control will be described. The congestion follow-up travel control involves the detection of the distance between the subject vehicle and the preceding vehicle using a radar apparatus or the like. In addition, the congestion follow-up travel control involves the automatic starting and stopping of the subject vehicle in response to the starting and the stopping of the preceding vehicle. The braking force at the time of stopping the vehicle is supplied as the brake-fluid pressure generated by the operation of the slave cylinder 23 without the driver's depressing the brake pedal 12. Accordingly, frequent braking actions of the driver are no longer necessary when the congestion follow-up travel control is in operation. The load/burden of actions required of the driver can be reduced.

Specifically, when the electric motor 52 of the slave cylinder 23 is driven in one direction, the output shaft 59 moves forward through the operation involving the drive bevel gear 53, the driven bevel gear 54, and the ball screw mechanism 55. The forward movement of the output shaft 59 pushes the pair of pistons 38A and 38B, so that the pair of pistons 38A and 38B move forward. The inlet ports 40A and 40B connected respectively to the fluid passages Pa and Qa get closed immediately after the start of the forward movement of the pistons 38A and 38B. As a consequence, brake-fluid pressure is generated in the second hydraulic chambers 39A and 39B. The brake-fluid pressure thus generated is transmitted to the wheel cylinders 16, 17, 20, and 21 via the opened regulator valves 61, 61 of the ABS 24 as well as the in-valves 42 thereof to brake the wheels, respectively.

Note that two parallel systems of fluid passages are provided at this time, respectively, to connect the master cylinder 11 to the wheel cylinders 16 and 17 and to connect the master cylinder 11 to the wheel cylinders 20 and 21. Accordingly, when one of the two systems fails, the other one can provide the back-up for the failed one. In addition, the provision of only one slave cylinder 23 to provide brake-fluid pressure to the fluid passages of the two systems reduces the number of the component parts.

As described above, when an automatic braking control is executed independently of the braking action of the driver, as in the case of the congestion follow-up travel control, the brake-fluid pressure generated by the hydraulic pumps 47, 47 activated by the electric motor 48 of the ABS 24 may be used. In this case, a problem results from the vibrations and noise accompanying the operation of the hydraulic pumps 47, 47. By contrast, in this exemplary embodiment, much improved silent operation can be obtained, in comparison with the vibrations and noise of the hydraulic pumps 47, 47, by the use of the brake-fluid pressure generated by the operation of the electric motor 52 of the slave cylinder 23. In addition, the relatively low brake-fluid pressure needed for the congestion follow-up travel control can be generated by the use of the brake-fluid pressure generated by the operation of the electric motor 52 of the slave cylinder 23 with more precision than by the hydraulic control through the opening and the closing of the in-valves 42 and the out-valves 44 of the ABS 24. At this time, a feedback control is executed on the operation of the electric motor 52 so as to make the actual brake-fluid pressure detected by a hydraulic sensor Sa provided in the fluid passage Qc equal to the target brake-fluid pressure that the slave cylinder 23 should generate.

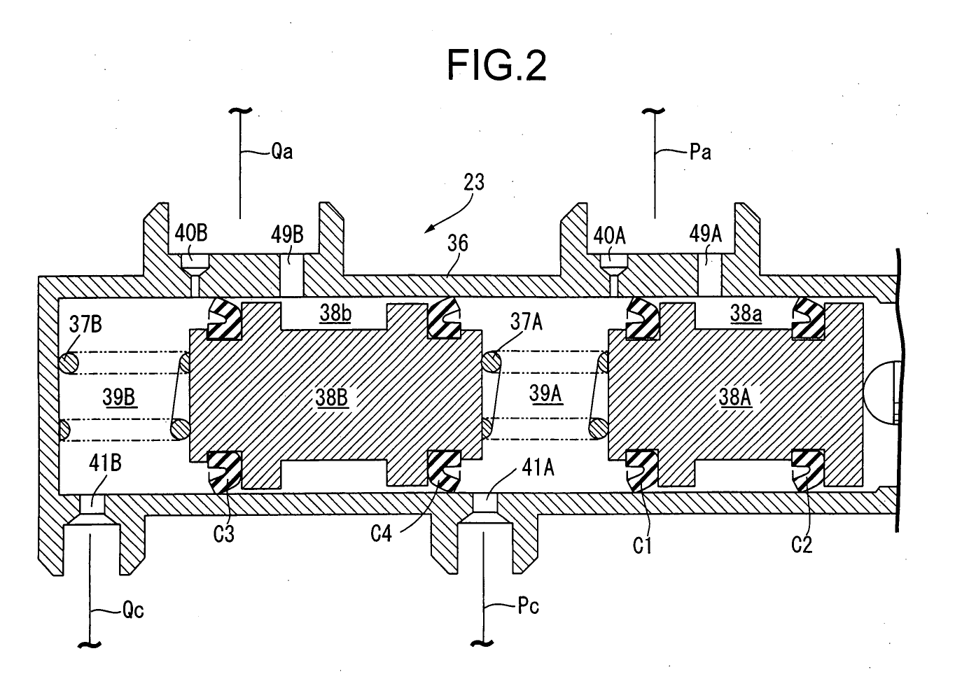

Suppose a case where the driver depresses the brake pedal 12 while the above-described slave cylinder 23 is in operation. In this case, the inlet ports 40A, 40B of the slave cylinder 23 are closed by the pistons 38A and 38B, respectively, and therefore the brake-fluid pressure generated by the master cylinder 11 is blocked at the inlet ports 40A and 40B. The brake-fluid pressure transmitted from the master cylinder 11, however, proceeds to the reservoir chamber 38a of the piston 38A through the opened supply port 49A and to the reservoir chamber 38b of the piston 38B through the opened supply port 49B. When the brake-fluid pressure transmitted to the reservoir chambers 38a and 38b exceeds the brake-fluid pressure generated in the second hydraulic chambers 39A and 39B of the slave cylinder 23, referring to FIG. 2, the brake fluid in the reservoir chamber 38a passes through the first cup seal C1 to flow into the second hydraulic chamber 39A, and the brake fluid in the reservoir chamber 38b passes through the third cup seal C3 to flow into the second hydraulic chamber 39B. The brake fluid that flows into the second hydraulic chamber 39A can activate the wheel cylinders 16 and 17, while the brake fluid that flows into the hydraulic chamber 39B can activate the wheel cylinders 20 and 21.

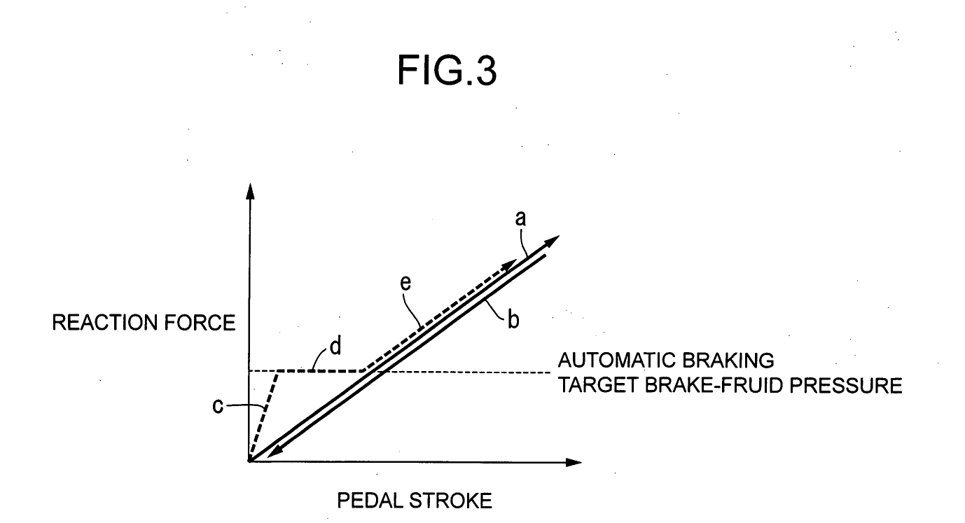

A description for the above-described case will be given based on FIG. 3. The horizontal axis of the graph shown in FIG. 3 represents the stroke of the brake pedal 12, and the vertical axis represents-the reaction-force (pedal force) of the brake pedal 12. Suppose a case where the driver depresses the brake pedal 12 while the slave cylinder 23 is not in operation. In this case, as the stroke of the brake pedal 12 increases, the reaction force increases linearly (see the solid line a). When the brake pedal 12 is returned to the original position, the reaction force decreases linearly with the decrease in the stroke of the brake pedal 12 (see the solid line b).

Meanwhile, suppose a case where the driver depresses the brake pedal 12 while the slave cylinder 23 is in operation. In this case, the brake pedal makes almost no stroke, and a reaction force corresponding to the brake-fluid pressure generated by the slave cylinder 23 is rapidly generated (see the broken line c). When the driver further depresses the brake pedal 12, the first cup seal C1 and the third cup seal C3 are opened. As a consequence, while the reaction force is kept constant, the stroke increases (see the broken line d). After that, both the stroke and the reaction force increase along the solid line a (see the broken line e).

The reaction force is kept constant as represented by the broken line d for the following reason. While the congestion follow-up travel control is in operation, the brake-fluid pressure in the second hydraulic chambers 39A and 39B of the slave cylinder 23 is put under a feedback control so as to achieve the target brake-fluid pressure. In this case, when the brake-fluid pressure from the master cylinder 11 is applied to the second hydraulic chambers 39A and 39B of the slave cylinder 23, the pistons 38A and 38B move backward so as to keep the brake-fluid pressure of the second hydraulic chambers 39A and 39B at the target brake-fluid pressure through the feedback control. Accordingly, in the state represented by the broken line e, the pistons 38A and 38B of the slave cylinder 23 return back to their respective backward positions, and both of the inlet ports 40A and 40B are left opened. For this reason, when the brake pedal 12 is returned to the original position, the relation between the stroke and the reaction force is the characteristic represented by the solid line b.

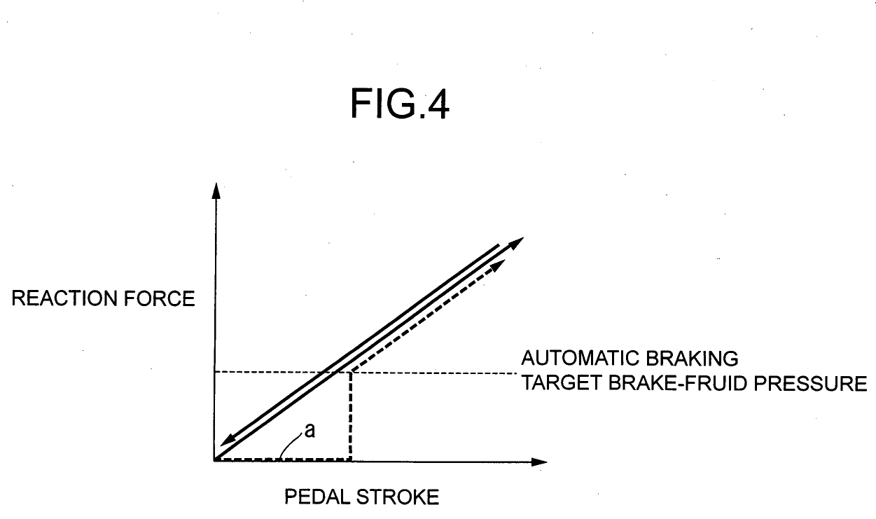

As described above, when the driver depresses the brake pedal 12 during the automatic braking control with the slave cylinder 23 in operation, the pedal force of the brake pedal 12 rises abruptly. Accordingly, the present invention significantly reduces or minimizes the strange sensation experienced by the driver in a conventional system having both a master cylinder and a motor-driven slave cylinder which generate brake-fluid pressure, i.e., the corresponding feeling of the driver at the time when the brake pedal 12 makes a stroke with no load at all, which happens when the automatic braking control is carried out using the vacuum booster described above with reference to FIG. 4. In addition, the slave cylinder 23 is activated only when the automatic braking control is in operation. Accordingly, simultaneous occurrence of the operation of the slave cylinder 23 and the braking action of the driver becomes less frequent. This can reduce an impact of the operation of the slave cylinder 23 on any unusual sensations experienced by the driver at the time of the braking action.

An exemplary embodiment of the present invention has been described thus far, but various modifications in design can be made without departing from the gist of the present invention.

For example, the ABS 24 is provided in the above-described exemplary embodiment between the slave cylinder 23 on one side and the wheel cylinders 16, 17, 20, and 21 on the other side. In an alternative configuration, the slave cylinder 23 may be directly connected to the wheel cylinders 16, 17, 20, and 21.

What is claimed is:

1. A braking system comprising:
wheel cylinders that brake respective wheels when brake-fluid pressure is applied to the wheel cylinders;
a master cylinder that generates brake-fluid pressure in response to a braking action of a driver; and
an actuator including a slave cylinder and an electric motor, which is disposed between the master cylinder and the wheel cylinders, and which generates brake-fluid pressure by a forward motion of a piston driven by a driving power of the electric motor;
wherein the actuator is activated by an electric signal independent of a braking action of the driver, and
wherein the actuator is activated only when the wheel cylinders are to be automatically activated without relying on the braking action of the driver

2. The braking system according to claim 1 further comprising a brake-fluid pressure adjusting device which is disposed between the slave cylinder and the wheel cylinders, and which adjusts, individually, the brake-fluid pressure supplied to the wheel cylinders.

3. The braking system according to claim 1, wherein
the slave cylinder includes:
a cylinder main body into which the piston is slidably fitted;
a port which is formed in the cylinder main body, and which communicates with the master cylinder;
a cup seal disposed on the piston; and
a reservoir chamber which is formed in an outer circumference of the piston and at a position located at a rear side of the cup seal, and which communicates with the master cylinder,
wherein when the piston moves forward and thereby the cup seal passes by the port, the slave cylinder generates brake-fluid pressure, and
when the actuator is automatically activated, the slave cylinder is put under a feedback control so as to make the slave cylinder generate a target brake-fluid pressure.

4. The braking system according to claim 1 further comprising two parallel systems of fluid passages connecting the master cylinder and the wheel cylinders,
wherein the slave cylinder provides brake-fluid pressure to the fluid passages of both of the parallel systems.

5. The braking system according to claim 1,
wherein the actuator is activated during the operation of a congestion follow-up travel control so that brake-fluid pressure from the actuator makes a subject vehicle automatically start and stop in response to starting and stopping of a preceding vehicle.

6. The braking system according to claim 1, further comprising:
a controller which provides the electric signal which activates the actuator.

7. The braking system according to claim 1,
wherein the brake-fluid pressure of the master cylinder is provided to the wheel cylinders through the slave cylinder under normal operation of the braking system.

8. An automatic-braking actuator which carries out a braking control by supplying brake-fluid pressure to wheel cylinders which are provided for respective wheels, the automatic-braking actuator comprising an electric motor that generates brake-fluid pressure by driving forward a piston slidably fitted into a cylinder main body, and
wherein the electric motor is activated only when the wheel cylinders are to be automatically activated without relying on any braking actions of a driver.

9. The automatic-braking actuator according to claim 8,
wherein the electric motor is activated during a congestion follow-up travel control so as to make a subject vehicle automatically start and stop in response to starting and stopping of a preceding vehicle.

10. The automatic-braking actuator according to claim 8, further comprising:
a controller which provides an electric signal which activates the actuator.
